(19) United States
(12) Patent Application Publication
(10) Pub. No.: US 2008/0244643 A1
(43) Pub. Date: Oct. 2, 2008

(54) System and Method for Alphanumeric Channel-Changing

(75) Inventors: Robert Virzi, Wayland, MA (US); Joel Angiolillo, Weston, MA (US)

Correspondence Address: VERIZON;PATENT MANAGEMENT GROUP, 1515 N. COURTHOUSE ROAD, SUITE 500, ARLINGTON, VA, 22201-2909, US

(73) Assignee: Verizon Laboratories Inc., Waltham, MA (US)

(21) Appl. No.: 11/693,758

(22) Filed: Mar. 30, 2007

(51) Int. Cl. H04N 5/445; G06F 7/00

(52) U.S. Cl. 725/37; 707/7; 725/52

(57) ABSTRACT

Embodiments of the present disclosure are directed to a method and system for alphanumeric channel-changing comprising receiving one or more entries corresponding to a name of a channel, matching the name of the channel against channel data stored in at least one database to form a match, and providing the channel corresponding to the one or more entries based on the match.

### BACKGROUND INFORMATION

Televisions are extremely popular with consumers. Because of advances in recent technology, television-watching has evolved into a multimedia experience. For example, consumers may now watch TV in high-definition on a large flat-screen with stereo surround sound in the comfort of their homes. The experience is further enhanced by the variety of television programs provided by TV service providers. Traditionally, consumers selected a desired TV channel by entering a numeric value on a remote control device corresponding to the numeric value of the desired TV channel. However, as the number of TV channels have increased, remembering all the corresponding channel numbers is becoming more difficult. Using channel-up/channel-down buttons and program guides have provided another way to locate and select a desired TV channel. However, scrolling through channels one by one, through blocks of channels, and/or managing a program guide having many channels is rather cumbersome. As a result, traditional systems and techniques are inefficient for changing channels as the number of channels continue to rapidly increase.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIG. 1 depicts an illustration of a system architecture, according to an exemplary embodiment of the present disclosure;

FIG. 2 depicts an illustration of a remote control device, according to an exemplary embodiment of the present disclosure;

FIG. 3 depicts an illustration of a remote control device, according to an exemplary embodiment of the present disclosure;

FIGS. 4A-4C depict an illustration of alphanumeric channel-changing, according to an exemplary embodiment of the present disclosure;

FIGS. 5A-5C depict an illustration of alphanumeric channel-changing, according to an exemplary embodiment of the present disclosure;

FIGS. 6A-6C depict an illustration of alphanumeric channel-changing, according to an exemplary embodiment of the present disclosure;

FIGS. 7A-7C depict an illustration of alphanumeric channel-changing, according to an exemplary embodiment of the present disclosure;

FIGS. 8A-8C depict an illustration of alphanumeric channel-changing, according to an exemplary embodiment of the present disclosure;

FIGS. 9A-9C depict an illustration of alphanumeric channel-changing, according to an exemplary embodiment of the present disclosure; and

FIG. 10 depicts an illustrative flowchart for alphanumeric channel-changing, according to an exemplary embodiment of the present disclosure.

### DETAILED DESCRIPTION OF EMBODIMENTS

A system and process of an exemplary embodiment of the present disclosure provides various alphanumeric channel-changing features. Technological advances in TV broadcasting as well as consumer affordability has made TV programs all over the world much more accessible. As TV service providers offer more and more channels to choose from, traditional techniques for navigating TV programs are becoming increasingly difficult and cumbersome to use.

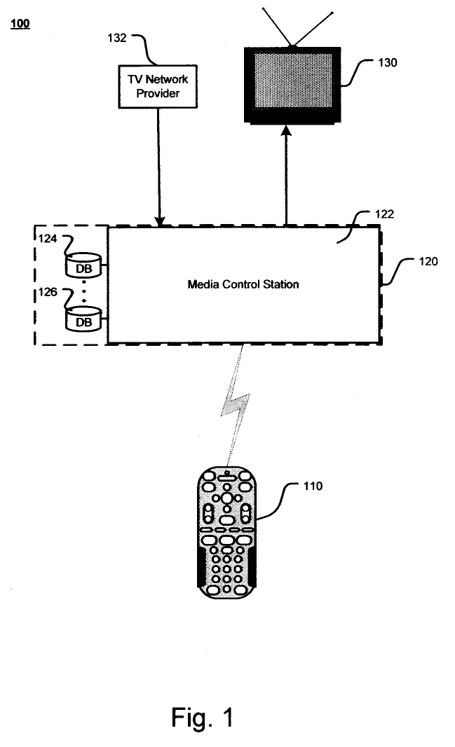

FIG. 1 depicts an illustrative alphanumeric channel-changing system architecture, according to an exemplary embodiment of the present disclosure. System 100 may comprise a remote control 110, a media box 120, and a display device 130. The display device 130 may include a TV, monitor, or other display device. Media box 120 may include a media control station 122 and one or more databases 124, 126. The media control station 122 may include a receiver to receive one or more commands/signals from the remote control device 110, a receiver to receive a media signal (e.g., streaming media, etc.) from one or more network providers (e.g., TV network provider 132, etc.) via a network (e.g., Internet, cable, satellite, etc.), and an output to transmit the media signal to the display device 130. The media signal may include additional information to and from the one or more network provider as well as other parties. Other variations and components may also be provided, such as a viewer interface, additional inputs/outputs, etc.

Databases 124, 126 may store relevant information received from the one or more TV network providers or other party. Exemplary database information may include TV network information, TV channel number, TV channel name, program listings, program schedules for each of the programs, future and past programming information, ratings, and/or other information provided by one or more network providers or other party. While shown as two separate databases, it should be appreciated that the contents of these databases 124, 126 may be combined into fewer or greater numbers of databases and may be stored on one or more data storage systems (e.g., one or more servers or other data storage system/media). Furthermore, the databases 124, 126 may be local, remote, or a combination thereof to the media box 120. For instance, databases may be connected to the media control station 122 within the media box 120, as depicted in FIG. 1, or connected to the media control station 122 via a network (e.g., Internet) from a remote server or other remote location (not shown). Databases 124, 126 may also store relevant information for personalized subscriber services. These may include user/viewer channel preferences, preferred TV programs/channels, preferred TV viewing times, etc. Such information may be useful to provide additional customizations for an enhance TV viewing experience.

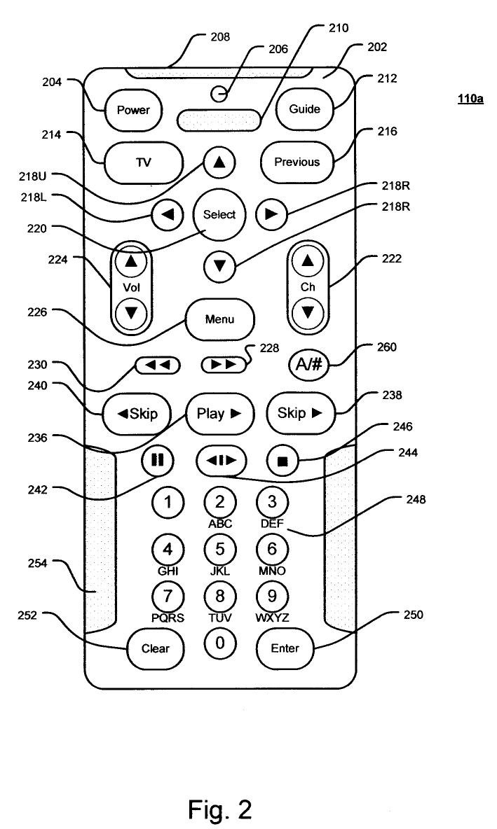

FIG. 2 depicts an exemplary illustration of a remote control device 110a, according to an embodiment of the present disclosure. While specifics of a wireless remote control device are discussed below, it should be appreciated that embodiments of the present disclosure are applicable to a variety of remote control devices. As such, embodiments of the present disclosure may provide alphanumeric channel-changing features independent of any particular remote control technology. For example, these features may be utilized with technology provided by other components, such as TVs, personal video recorders (PVRs) or digital video recorders (DVRs), or set top boxes, including a media control station 122 of a media box 120, etc. Other various components and technologies may also be provided.

Remote control device 110a may include a body or frame 202, light indicator 206, a wireless output 208, an a logo area 210, variety of buttons 204, 212-252 on the face of the remote control 200 for a user/viewer to input one or more commands, and gripping pads 254.

The body 202 may be formed of various types of materials and in a variety of shapes. In one embodiment, the body 202 may have a rectangular shape with rounded corners. Other shapes, such as a curvier shape for improved gripping, may also be provided. In another embodiment, the body 202 may be made of a plastic or metal material. Other various materials, such as hard rubber or other similar material, may also be used.

The remote control device 110a may send user commands to the media control station 122 at the media box 120 via the wireless output 208. Signal transmission from the wireless output 208 may include a variety of wireless signaling pathways, such as infrared, Bluetooth™, local area wireless network (e.g., 802.11 based protocols), and/or other similar signaling applications between the media box 120 and the remote control device 110a. In one embodiment, the remote control device 110a may have a wired output, e.g., a game pad controller. Other various embodiments may also be provided.

A number of buttons may exist on the remote control device 110a. Power button 204 may be used by a viewer to turn on or off the media box 120. Power button 204 may also be used as a universal control to turn on other devices, such as the display device 130 and/or other peripheral devices. Light indicator 206 may be of one color (e.g., green) when the power is on. Light indicator 206 may blink or emit light of another color when other buttons are pressed to indicate, for example, signal transmission. Guide button 212 may be used to view a menu or index of media. TV button 214 may be pressed to switch from various modes of output channels, such as TV, Video 1, Video 2, Component, Auxiliary, etc. “Previous” button 216 may be used by a viewer to repeat a previous action, e.g., display previously viewed channel. Arrows 218U, 218R, 218R, 218L may be used to maneuver menu options. Select button 220 may be used to select menu options. In one embodiment, the arrows may be on one ring-shaped button to include diagonal-pointing arrows. Volume button 224 may be used to control the level of volume from the media box 120 to the display device 130. Channel button 222 may be used to flip and/or scroll through channels in ascending or descending order. Menu button 226 may be used to display a menu of options. Fast Forward button 228 may be used to perform fast forwarding functions at predetermined speeds. Rewind button 230 may be used to perform rewind or reverse progression functions at predetermined speeds. Skip Forward 238 and Skip Back button 240 may be used to initiate and perform customizable skip forward and skip back features, respectively. Play button 236 may be used to initiate and execute playback. Pause 242 may be used to pause playback at any given frame. Stop 246 may be used to stop playback at any given frame. Slow Motion button 244 may be used to move forward or backward frame by frame (or multiple frames at a time) within a particular media stream. Alphanumeric Keypad 248 may be used to enter alphanumerical information and/or commands. Enter 250 may be used to select menu features and/or submit an alphanumeric entry. Clear 252 may be used to reset a viewing feature or erase an alphanumeric entry.

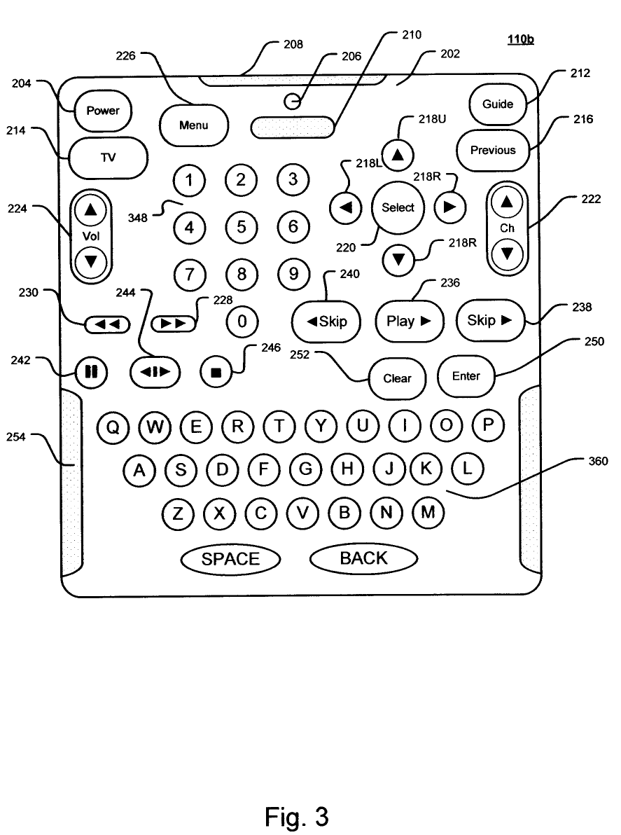

FIG. 3 depicts another exemplary illustration of a remote control device 110b, according to an embodiment of the present disclosure. Although FIG. 3 is a variation of FIG. 2, it should be understood in relation to FIG. 2 in that the features and relationship between elements as described in relation to FIG. 2 should apply to FIG. 3 as well. For example, the remote control device 110b of FIG. 3 may include many of the same buttons/features of the remote control device 110a in FIG. 2. However, instead of an Alphanumeric Keypad 248, as depicted in FIG. 2, the remote control device 110b may include a Numerical Keypad 348 and a separate Alphabetic Keypad 360. The advantages of having a separate Alphabetic Keypad 360 having a full set of alphabetic keys are discussed in further detail below.

It should be appreciated by one of ordinary skill in the art that remote control devices come in a variety of shapes, sizes, textures, and functionalities with an assortment of buttons and/or labels. Additionally, remote control devices may use various technologies (e.g., wired or wireless technologies) to communicate with external devices. Furthermore, other devices having alphanumeric capabilities may be used as remote control devices as well. These may include desktop computers, laptops, game controllers, mobile communication devices, such as personal digital assistants (PDAs), mobile phones, smart phones, as well as other devices that may transmit and/or receive signals to/from the media box 120.

Navigating TV programs typically involves memorization and entry of numerical values corresponding to TV channels. Without the use of a cross-reference guide (such as a paper-based TV guide or an electronic program guide) to match a TV network to its local channel number, this may be extremely difficult to quickly and easily find the desired TV program when there are hundreds of channels to navigate, especially when four to eight (4-8) channels options may be displayed at a given time on the screen. Changing channels incrementally may also be extremely time-consuming and inefficient in selecting the desired TV program. Accordingly, embodiments of the present disclosure may provide an easier technique for changing channels by providing alphanumeric channel-changing features.

According to exemplary embodiments of the present disclosure, many users/viewers may already know what TV networks carry their favorite TV programs. Rather than entering a channel number, which may vary from locality to locality, or scrolling through a program guide, a user/viewer may directly enter the name (or part of the name) of the TV network carrying the program on a remote control device (or other similar device) having alphanumeric capabilities. For example, in order for a viewer to see what movie is playing on the HBN movie channel, he or she may then enter the buttons on his or her remote control device corresponding to H-B-N to change to the HBN channel. Once the channel has changed to the HBN movie channel (which may be playing a movie that the viewer has seen before), the viewer remembers that his or her favorite weekly TV sitcom is showing on the ABB channel. Once again, the viewer enters the name of the channel—A-B-B—on his or her remote control. Once the name is entered, the show may be displayed on the viewer's TV display. However, the viewer may have just caught the last minute of the show and now decides to view a sporting event on one of many sports channels. The viewer may enter the first two letters of the channel—S-P—and an auto-completion mode may complete the entry. For example, the TV may display a menu showing several channels starting with the letters “SP,” such as SPA, SPE, and SPO. Looking at the options provided in the menu, the viewer may recall that SPA is the relaxation channel, SPE is the special news channel, and SPO is the sports channel. At this point, the viewer may select the SPO channel with the arrow buttons on the remote control device 110 and begin watching the sporting event on the TV set. Thus, a partial entry may initiate one or more partial matches so that the auto-completion may indicate the relevant channels from which the user may select. In one embodiment, a processor within the media control station 122 may perform the one or more partial matches. In another embodiment, the one or more partial matches may be sorted and/or presented by at least one of the following: alphabetically (or numerically), by frequency of use (or viewing) by the viewer, by popularity/ratings over a range (or network) of viewers, etc. Other various embodiments may also be provided.

While channels, e.g., HBN, ABB, SPO, etc., are described above as being a channel names, it should be appreciated by one of ordinary skill that the channels may be networks corresponding to service provider channels rather than channels themselves. For example, HBN may be a network provider and may have several channel names that correspond to the network, such as HBN, HBN1, HBN-Classic, etc. Accordingly, even though the disclosure refers to a channel as a channel “name,” it should be appreciated and understood as a network corresponding to a service provider channel.

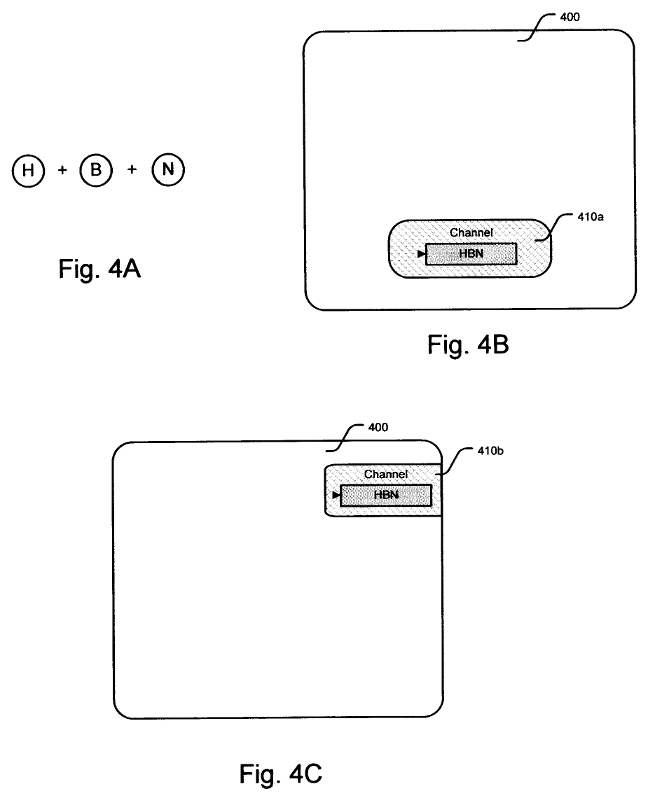

FIGS. 4A-4C depict an illustration of alphanumeric channel-changing in accordance with an exemplary embodiment of the present disclosure described below. In this example, alphanumeric channel-changing may be achieved by using a remote control device 110b having an alphanumeric keypad 360 (as depicted in FIG. 3). Here, as depicted in FIG. 4A, a user who desires to watch a TV program on a well-known movie channel, such as HBN, for example, may press one or more entries, e.g., “H”, “B”, and “N”, on the keypad 360 to spell out the name of the channel. In one embodiment, the one or more entries may be entered in sequential order and/or within a predetermined amount of time of each other, such as 1-2 seconds. After the one or more entries corresponding to the name of the channel/network (e.g., HBN) are entered in the remote, the media control station 122 may receive a command or signal including the one or more entries. In one embodiment, the command including the one or more entries may be sent to the media control station 122 after a predetermined amount of time (e.g., 1-5 seconds, etc.) has elapsed without any further entry. Alternatively, in another embodiment, the command including the one or more entries may be sent to the media control station 122 by pressing another button, such as Enter 250, on the remote control device 110b. Once the one or more entries are received, the media control station 122 may match the one or more entries with channel data stored in one or more databases 124, 126. The channel data may include a variety of channel information, such as channel number, channel name, program listings, length of TV programs, ratings, etc. In one embodiment, the channel information may be stored in the form of metadata in the channel data.

Referring back to this example for alphanumeric channel-changing, the “HBN” command received by the media control station 122 from the remote control device 110b may be matched against the “HBN” channel name (which corresponds to the HBN movie channel) stored in the channel data within the one or more databases 124, 126 to form a match. In one embodiment, a processor within the media control station 122 may perform the match. Once a match is made, the media control station 122 may transmit the signal from the “HBN” channel to the display device 130 (e.g., TV, monitor) for the user to view. FIG. 4B depicts an exemplary screenshot of a video broadcast 400 from the HBN channel. The screenshot may also include a menu 410a at the display device 130 to indicate the name of the channel that is being displayed on the screen 400. In one embodiment, the menu 410a may overlay the display at the screen 400. In another embodiment, the menu 410a may be semi-transparent so that the display at the screen 400 may also be viewed. In yet another embodiment, the menu may be displayed on the screen 400 where the show may be displayed in a small window on the screen, e.g., picture-in-picture (PIP). Other various embodiments may also be considered.

As depicted in FIG. 4C, the menu 410b displaying the displayed channel may also be of varying sizes and may be positioned at various locations on the video screen 400. In this example, the menu 410b is a small menu positioned at a periphery (e.g., upper right-hand corner) of the screen 400 to provide the user a better view of the streaming TV program. Other variations may also be provided.

It should be appreciated by one skilled it the art that a match may be a full match or a partial match. In the event a partial match is made, an auto-completion feature may initiate. For example, when a user enters “HB” (instead of the full “HBN”), the auto-completion may prompt the user with “HBN”, especially if HBN is the only channel name that starts with “HB.” If there are more than one channel that start with “HB,” the auto-completion feature may provide a drop-down menu to select the particular channel starting with “HB.” In another embodiment, the auto-completion feature may be user-sensitive. For example, if a user frequents a particular channel (or frequents a particular channel at a certain time of day or during the week), the auto-completion feature may store this information in the one or more databases 124, 126. As a result, if a user likes to watch his or her weekly movie on the “HBN” channel, as the user enters one or more entries (“HB” or even “H”), the autocompletion feature may recognize that the user wants to watch his weekly movie on HBN and provide the auto-completion of the entry to “HBN.” This may be especially convenient if there are many channel names that have the same first few letters, but in which the user prefers to watch only one of them, such as the movie channel.

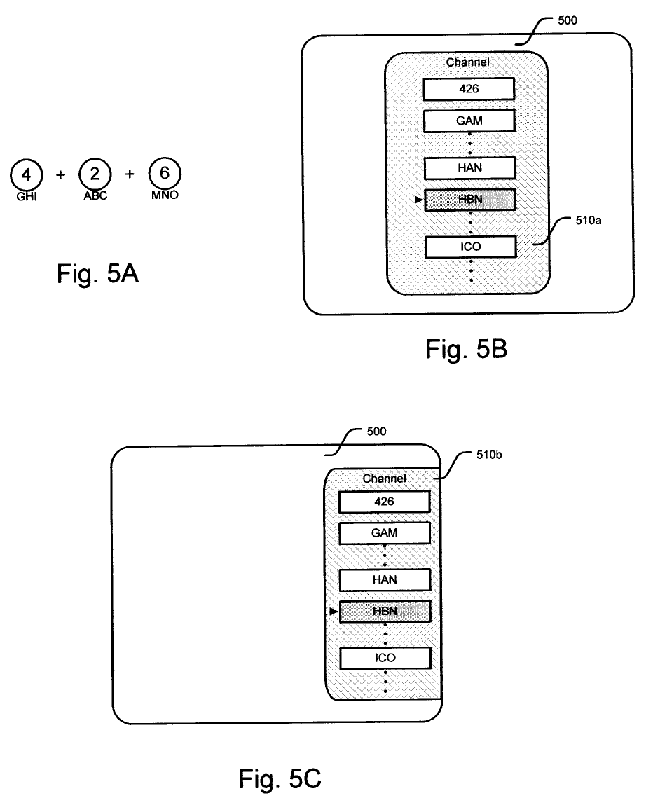

FIGS. 5A-5C depict an exemplary illustration of alphanumeric channel-changing, according to an embodiment of the present disclosure. In this example, alphanumeric channel-changing may be achieved by using a remote control device 110a having an alphanumeric keypad 248 (as depicted in FIG. 2). Here, as depicted in FIG. 5A, a user who desires to watch a TV program on a well-known movie channel, such as HBN, may press one or more entries, e.g., “4”, “2”, and “6” (each of which correspond to the letters of the desired channel—“4-GHI”, “2-ABC”, and “6-“MNO”) on the alphanumeric keypad 248 in sequential order and within a predetermined amount of time to spell out a three digit entry corresponding to the desired TV channel. After the one or more entries are entered in the remote, the media control station 122 may receive a command or signal including the one or more entries. In one embodiment, the command including the one or more entries may be sent to the media control station 122 after a predetermined amount of time (e.g., 1-5 seconds, etc.) has elapsed without any further entry. Alternatively, in another embodiment, the command including the one or more entries may be sent to the media control station 122 by pressing another button, such as Enter 250, on the remote control device 110a. Once the one or more entries are received, the media control station 122 may match the one or more entries with channel data stored in one or more databases 124, 126. The channel data may include a variety of channel information, such as channel number, channel name, program listings, length of TV programs, ratings, etc. In one embodiment, the channel information may be stored in the form of metadata in the channel data.

Referring back to this example, the command including the one or more entries received by the media control station 122 from the remote control device 110b may be matched against the channel information (such as channel number and channel name) stored in the channel data within the one or more databases 124, 126 to form one or more matches. In this case, several matches may be formed from the attempted “HBN” entry. FIG. 5B depicts and exemplary screenshot of a video broadcast 500 displaying a menu 510a at the display device 130, listing each of the channels that numerically and alphabetically correspond to the one or more entries (e.g., “HBN”). For example, the intended “HBN” entry may pull up a menu 510a with these various possible channel matches: “426” (channel number 426), “GAM” (Gameshow Channel) . . . “HAN” (Handyman Network), “HBN” (the user's desired movie channel) . . . “ICO” (Imagination Company Channel). The viewer may use arrows, e.g., up 218U and/or down 218D, and the Select button 220 (or Enter button 250) to select the desired channel (e.g., “HBN”) to view in the video broadcast 500. Alternatively, in another embodiment, the desired channel may be selected without pressing the Select button 220 but rather by allowing the arrow indicator to sit at the desired channel for a predetermined period of time, e.g. one second. Once the viewer chooses the intended desired channel, the media control station 122 may pass the signal of the desired channel (e.g., “HBN”) from the TV service provider to the display device 130 (e.g., TV, monitor) for the user to view.

As depicted in FIG. 5C, the menu 510b displaying the one or more channel matches may also be of varying sizes and may be positioned at various locations on the video screen 500. In this example, the menu 510b is a small menu positioned at a periphery (e.g., upper right-hand corner) of the screen 500 to provide the user a better view of the streaming TV program. Other variations may also be provided.

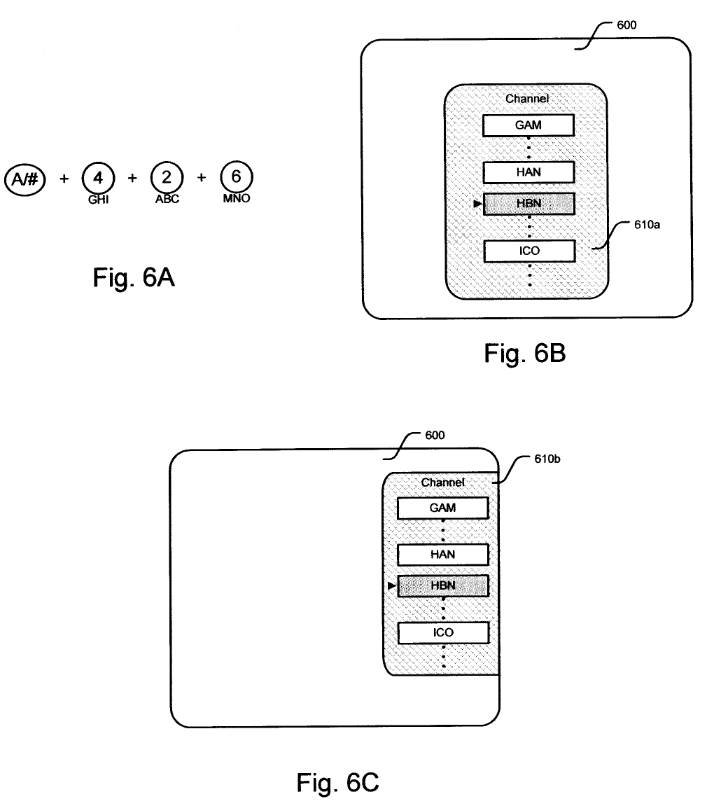

FIGS. 6A-6C depict an exemplary illustration of alphanumeric channel-changing, according to an embodiment of the present disclosure. In this example, alphanumeric channel-changing may be achieved by using a remote control device 110a having an alphanumeric keypad 248 (as depicted in FIG. 2). Here, as depicted in FIG. 6A, a user who desires to watch a TV program on a well-known movie channel, such as HBN, may press the alphabet mode button 260 to indicate that the following one or more entries will be alphanumeric values for alphanumerically changing channels. In this case the user may then press one or more entries, e.g., “4”, “2”, and “6” (each of which correspond to the letters of the desired channel—“4-GHI”, “2-ABC”, and “6-“MNO”) on the alphanumeric keypad 248 in sequential order and within a predetermined amount of time to spell out a three digit entry corresponding to the desired TV channel. After the one or more entries are entered in the remote, the media control station 122 may receive a command or signal including the one or more entries. In one embodiment, the command including the one or more entries may be sent to the media control station 122 after a predetermined amount of time (e.g., 1-5 seconds, etc.) has elapsed without any further entry. Alternatively, in another embodiment, the command including the one or more entries may be sent to the media control station 122 by pressing another button, such as Enter 250, on the remote control device 110a. Once the one or more entries are received, the media control station 122 may match the one or more entries with channel data stored in one or more databases 124, 126. The channel data may include a variety of channel information, such as channel number, channel name, program listings, length of TV programs, ratings, etc. In one embodiment, the channel information may be stored in the form of metadata in the channel data.

Referring back to this example, the command including the one or more entries received by the media control station 122 from the remote control device 110b may be matched against the channel information stored in the channel data within the one or more databases 124, 126 to form one or more matches. In this case, similar to FIGS. 5A-5C, several matches may be formed from the attempted “HBN” entry. However, because the alphabet mode button 260 was pressed before the one or more entries, the media control station 122 may recognize the command received from the remote control device 110a as alphabetic. As a result, FIG. 5B depicts and exemplary screenshot of a video broadcast 500 displaying a menu 510a at the display device 130, listing each of the channels that alphabetically correspond to the one or more entries (e.g., “HBN”). For example, the intended “HBN” entry may not pull up Channel 426 (as depicted in FIGS. 5B-5C) but rather may pull up a menu 510a with various possible alphabetical channel matches, such as “GAM” (Gameshow Channel) . . . “HAN” (Handyman Network), “HBN” (the user's desired movie channel) . . . “ICO” (Imagination Company Channel). Similar to FIGS. 5B-5C, the viewer may use arrows, e.g., up 218U and/or down 218D, and the Select button 220 (or Enter button 250) to select the desired channel (e.g., “HBN”) to view in the video broadcast 500. Alternatively, in another embodiment, the desired channel may be selected without pressing the Select button 220 but rather by allowing the arrow indicator to sit at the desired channel for a predetermined period of time, e.g. one second. Once the viewer chooses the intended desired channel, the media control station 122 may transmit the signal from the desired channel (e.g., “HBN”) to the display device 130 (e.g., TV, monitor) for the user to view.

As depicted in FIG. 6C, the menu 610b displaying the one or more channel matches may also be of varying sizes and may be positioned at various locations on the video screen 600. In this example, the menu 610b is a small menu positioned at a periphery (e.g., upper right-hand corner) of the screen 600 to provide the user a better view of the streaming TV program. Other variations may also be provided.

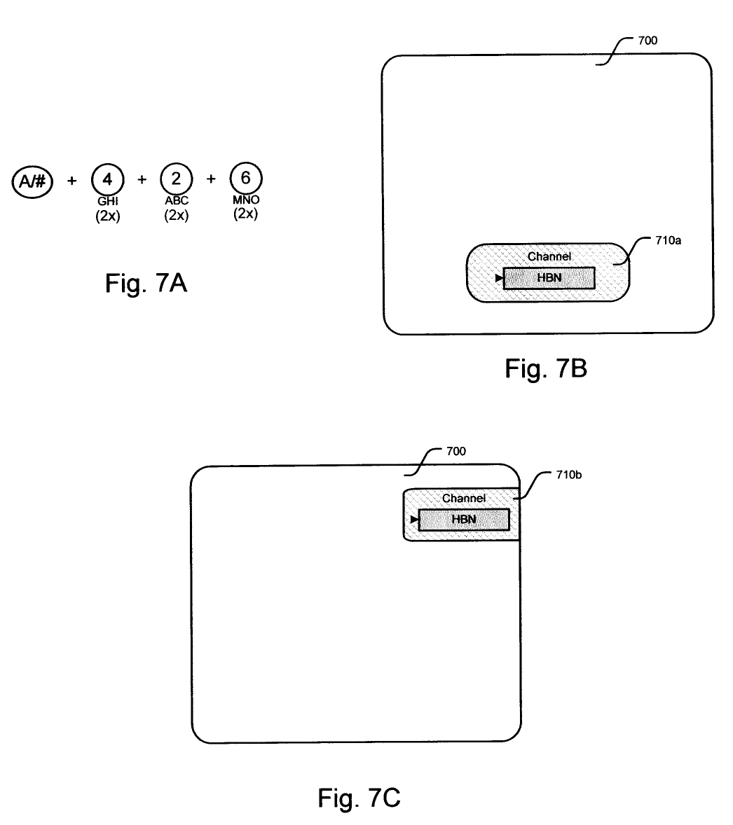

FIGS. 7A-7C depict an exemplary illustration of alphanumeric channel-changing, according to an embodiment of the present disclosure. In this example, alphanumeric channel-changing may be achieved by using a remote control device 110a having an alphanumeric keypad 248 (as depicted in FIG. 2). Here, as depicted in FIG. 7A, a user who desires to watch a TV program on a well-known movie channel, such as HBN, may press the alphabet mode button 260 to indicate that the following one or more entries will be alphabetic values. In this case, the user may then press one or more entries on the alphanumeric keypad 248 in sequential order and within a predetermined amount of time to spell out the name of the desired TV channel. For example, the user may enter “4” two times, “2” two times, and “6” two times (each of which correspond to the letters of the desired channel—“H”, “B”, and “N”, respectively). After the one or more entries are entered in the remote, the media control station 122 may receive a command or signal including the one or more entries. In one embodiment, the command including the one or more entries may be sent to the media control station 122 after a predetermined amount of time (e.g., 1-5 seconds, etc.) has elapsed without any further entry. Alternatively, in another embodiment, the command including the one or more entries may be sent to the media control station 122 by pressing another button, such as Enter 250, on the remote control device 110a. Once the one or more entries are received, the media control station 122 may match the one or more entries with channel data stored in one or more databases 124, 126. The channel data may include a variety of channel information, such as channel number, channel name, program listings, length of TV programs, ratings, etc. In one embodiment, the channel information may be stored in the form of metadata in the channel data.

Referring back to this example, the “HBN” command received by the media control station 122 from the remote control device 110a may be matched against the “HBN” channel name (which corresponds to the HBN movie channel) stored in the channel data within the one or more databases 124, 126 to form a match. Once a match is made, the media control station 122 may transmit the signal from the “HBN” channel to the display device 130 (e.g., TV, monitor) for the user to view. FIG. 7B depicts an exemplary screenshot of a video broadcast 700 from the HBN channel. The screenshot may also include a menu 710a at the display device 130 to indicate the name of the channel that is being displayed on the screen 700.

As depicted in FIG. 7C, the menu 710b displaying the one or more channel matches may also be of varying sizes and may be positioned at various locations on the video screen 700. In this example, the menu 710b is a small menu positioned at a periphery (e.g., upper right-hand corner) of the screen 700 to provide the user a better view of the streaming TV program. Other variations may also be provided.

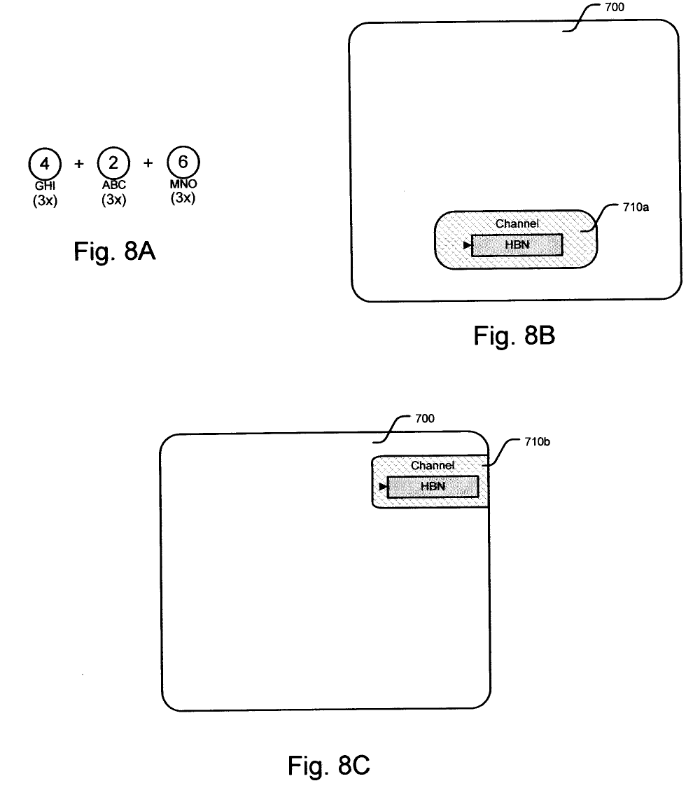

FIGS. 8A-8C depict an exemplary illustration of alphanumeric channel-changing, according to an embodiment of the present disclosure. In this example, alphanumeric channel-changing may be achieved by using a remote control device 110a having an alphanumeric keypad 248 (as depicted in FIG. 2): Unlike FIGS. 7A-7C, a user who desires to watch a TV program on a well-known movie channel, such as HBN, may directly enter the alphanumeric values on an alphanumeric keypad without pressing the alphabet mode button 260, as depicted in FIG. 8A. In this case, the user may press each of the one or more entries a specified number times on the alphanumeric keypad 248 in sequential order and within a predetermined amount of time to spell out the name of the desired TV channel. For example, the user may enter “4” three times, “2” three times, and “6” three times (each of which correspond to the letters of the desired channel—“H”, “B”, and “N”, respectively; for example: 1×=“4”, 2×=“G”, etc.). After the one or more entries are entered in the remote, the media control station 122 may receive a command or signal including the one or more entries. In one embodiment, the command including the one or more entries may be sent to the media control station 122 after a predetermined amount of time (e.g., 1-5 seconds, etc.) has elapsed without any further entry. Alternatively, in another embodiment, the command including the one or more entries may be sent to the media control station 122 by pressing another button, such as Enter 250, on the remote control device 110a. Once the one or more entries are received, the media control station 122 may match the one or more entries with channel data stored in one or more databases 124, 126. The channel data may include a variety of channel information, such as channel number, channel name, program listings, length of TV programs, ratings, etc. In one embodiment, the channel information may be stored in the form of metadata in the channel data.

Referring back to this example, the “HBN” command received by the media control station 122 from the remote control device 110a may be matched against the “HBN” channel name (which corresponds to the HBN movie channel) stored in the channel data within the one or more databases 124, 126 to form a match. Once a match is made, the media control station 122 may transmit the signal from the “HBN” channel to the display device 130 (e.g., TV, monitor) for the user to view. FIG. 8B depicts an exemplary screenshot of a video broadcast 800 from the HBN channel. The screenshot may also include a menu 810a at the display device 130 to indicate the name of the channel that is being displayed on the screen 800.

As depicted in FIG. 8C, the menu 810b displaying the one or more channel matches may also be of varying sizes and may be positioned at various locations on the video screen 800. In this example, the menu 810b is a small menu positioned at a periphery (e.g., upper right-hand corner) of the screen 800 to provide the user a better view of the streaming TV program. Other variations may also be provided.

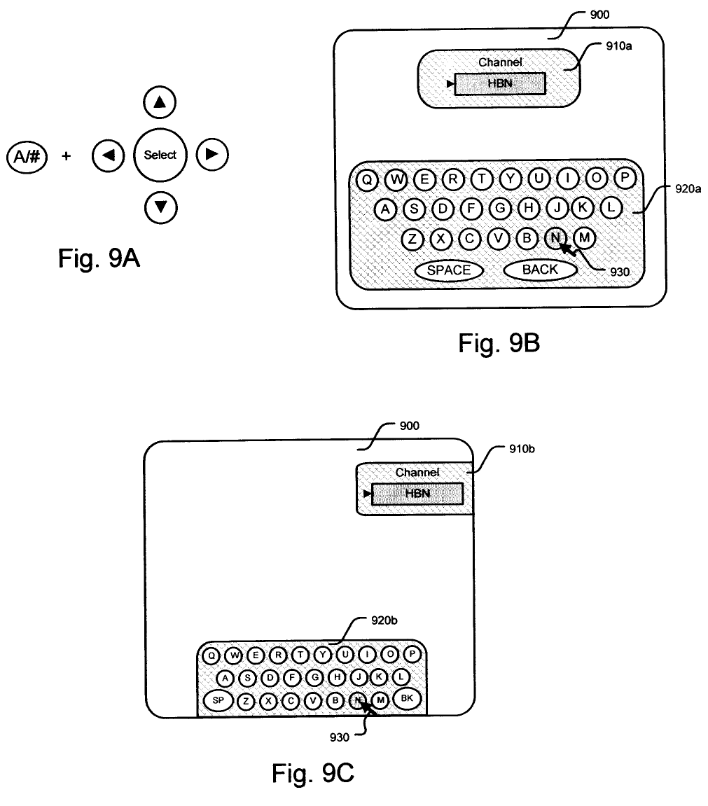

FIGS. 9A-9C depict an exemplary illustration of alphanumeric channel-changing, according to an embodiment of the present disclosure. In this example, alphanumeric channel-changing may be achieved by using a remote control device not necessarily having an alphabetic keypad or an alphanumeric keypad. For the purposes of illustration, the remote control device 110a of FIG. 2 will be used. Here, as depicted in FIG. 9A, a user who desires to watch a TV program on a well-known movie channel, such as HBN, may press the alphabet mode button 260 (or other similar key) to initiate an on-screen keyboard to appear. When the media control station 122 receives the on-screen keyboard command (initiated by the pressing of the alphabet mode button 260 or other button), the media box 120 displays an on-screen keyboard at the display device 130 for the user to view and select a channel. In this case, the user may use arrows, e.g., up 218U, down 218D, left 218L, and/or right 218R, and the Select button 220 (or Enter button 250) to spell out the spell out the name of the desired channel (e.g., “HBN”) to view in the video broadcast 900, as depicted in FIG. 9B. Alternatively, in another embodiment, the desired channel may be spelled out without pressing the Select button 220 but rather by allowing the arrow indicator to sit at the desired channel for a predetermined period of time, e.g. one second. After the one or more entries are entered using the on-screen keyboard via the remote control device 110a, the media control station 122 may match the one or more entries with channel data stored in one or more databases 124, 126. The channel data may include a variety of channel information, such as channel number, channel name, program listings, length of TV programs, ratings, etc. In one embodiment, the channel information may be stored in the form of metadata in the channel data.

Referring back to this example, the “HBN” command entered on the on-screen keyboard 920a may be matched against the “HBN” channel name (which corresponds to the HBN movie channel) stored in the channel data within the one or more databases 124, 126 to form a match. Once a match is made, the media control station 122 may transmit the signal from the “HBN” channel to the display device 130 (e.g., TV, monitor) for the user to view. FIG. 9B depicts an exemplary screenshot of a video broadcast 900 from the HBN channel. The screenshot may also include a menu 910a at the display device 130 to indicate the name of the channel that is being displayed on the screen 900.

As depicted in FIG. 9C, the menu 910b displaying the one or more channel matches may also be of varying sizes and may be positioned at various locations on the video screen 900. In this example, the menu 910b is a small menu positioned at a periphery (e.g., upper right-hand corner) of the screen 900 to provide the user a better view of the streaming TV program. Other variations may also be provided.

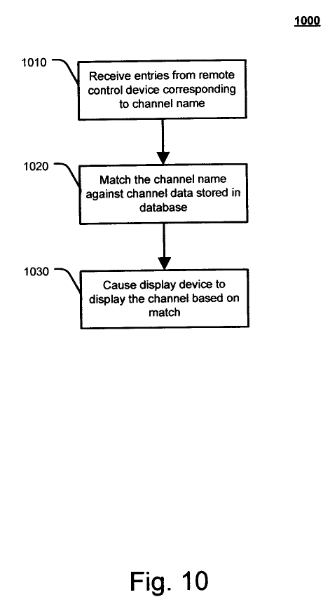

FIG. 10 depicts an illustrative flowchart for alphanumeric channel-changing, according to an exemplary embodiment of the present disclosure. At step 1010, one or more entries may be received. For example, the media box 120 (specifically the control station 122) may receive one or more entries (e.g., commands or signals) from a remote control device 110. In one embodiment, the one or more entries may correspond to a name of a channel. In another embodiment, the one or more entries may be received as one or more alphanumerical characters. For instance, each of the one or more alphanumerical characters may include a distinct numerical sequence corresponding to an alphanumerical character. In yet another embodiment, receiving the one or more entries may comprise receiving signals having alphanumeric entries. Other embodiments may also be provided.

At step 1020, the name of the channel may be matched. For example, the media control station 122 may match the name of the channel against channel data stored in one or more databases 124, 126 to form a match. In one embodiment, the channel data may include at least one of the following channel information: channel number, channel name, list of programs, program start and end times for each of the programs, and ratings. In another embodiment, the channel information may be stored in the form of metadata within the channel data. In yet another embodiment, the match may include at least one of a full match or a partial match. In yet another embodiment, matching the name of the channel may further include initiating an auto-completion function. In this example, the event the match may be a partial match and the auto-completion function may complete the name of the channel based on the partial match. Additionally, the one or more entries may similar features and functionalities to the embodiments described above. Other embodiments may also be considered.

At step 1030, the channel may be displayed. For example, the media control station 122 may cause the display device 130 to display the channel corresponding to the one or more entries based on the match. Other embodiments may also be provided.

It should be appreciated by one skilled in the art that any device capable of transmitting alphanumeric commands may function as a remote control device for the purposes of the embodiments described above. For example, a mobile phone with SMS-capability may send an alphanumeric channel-changing SMS to a media box 120, which may include a variety of alphanumerical command readers to process the alphanumeric channel-changing feature. Additionally, desktop, laptop, and mobile communications devices may also serve to provide remote control functionalities. Other various embodiments may also be provided.

While the embodiments described above may be directed to a media box 120, specifically the media control station 122, processing the alphanumeric channel-changing features, it should be appreciated to one of ordinary skill in the art that a remote control device 110 and/or a display device 130 may include processing capabilities to customize the features described above as well.

Although the embodiments described above are directed toward remote control devices, DVRs and PVRs, it may be readily appreciated that one or ordinary skill in the art may apply the features and functionalities of the system and method as discussed above to any video or audio application, such as DVDs players, VCRs, CD players, MP3 players, etc.

Although the embodiments described above are directed toward DVRs and PVRs, it may be readily appreciated that one or ordinary skill in the art may apply the features and functionalities of the system and method as discussed above to any video or audio application, such as DVDs players, VCRs, CD players, MP3 players, etc.

In the preceding specification, various embodiments have been described with reference to the accompanying drawings. It will, however, be evident that various modifications and changes may be made thereto, and additional embodiments may be implemented, without departing from the broader scope of the present disclosure as set forth in the claims that follow. The specification and drawings are accordingly to be regarded in an illustrative rather than restrictive sense.

1. A method, comprising:
receiving one or more entries corresponding to a name of a channel;
matching the name of the channel against channel data stored in at least one database to form a match; and
providing, at a display device, the channel corresponding to the one or more entries based on the match.

2. The method of claim 1, wherein the one or more entries comprises one or more alphanumerical characters.

3. The method of claim 2, wherein each of the one or more alphanumerical characters comprises a distinct numerical sequence corresponding to an alphanumerical character.

4. The method of claim 1, wherein the channel data comprises at least one of the following channel information: channel number, channel name, list of programs, program start and end times for each of the programs, and ratings.

5. The method of claim 4, wherein the channel information is stored in the form of metadata within the channel data.

6. The method of claim 1, wherein the match is at least one of a full match or a partial match.

7. The method of claim 6, wherein the method further comprises initiating an auto-completion function in the event the match is a partial match.

8. The method of claim 7, wherein the auto-completion function completes the name of the channel.

9. The method of claim 1, wherein receiving the one or more entries comprises receiving signals having alphanumeric entries.

10. A computer readable media comprising code to perform the acts of the method of claim 1.

11. A system, comprising:
a receiver to receive one or more entries from a remote control device, wherein the one or more entries corresponds to a name of a channel;
a processor to match the name of the channel against channel data stored in at least one database to form a match; and
an output to provide, at a display device, the channel corresponding to the one or more entries based on the match.

12. A method, comprising:
receiving one or more entries corresponding to at least a partial name of a channel;
matching the at least partial name of the channel against channel data stored in at least one database to form one or more matches;
outputting, at a display device, to display a channel menu comprising the one or more matches;
receiving a user selection command indicating a selected match from the one or more matches; and
providing, at the display device, the channel corresponding to the selected match.

13. The method of claim 12, wherein the one or more entries comprises one or more alphanumerical characters.

14. The method of claim 13, wherein each of the one or more alphanumerical characters comprises a distinct numerical sequence corresponding to an alphanumerical character.

15. The method of claim 12, wherein outputting a channel menu comprising the one or more matches further comprises displaying a full name of the channel corresponding to each of the one or more matches.

16. The method of claim 15, wherein the one or more matches are outputted for display in at least one of the following orders: alphabetically, numerically, by frequency of use, by popularity, and by rating.

17. The method of claim 12, wherein the channel data comprises at least one of the following channel information: channel number, channel name, list of programs, program start and end times, and ratings.

18. The method of claim 17, wherein the channel information is stored in the form of metadata within the channel data.

19. The method of claim 12, wherein the remote control device is a device comprising an alphanumeric capability.

20. A computer readable media comprising code to perform the acts of the method of claim 12.

21. A system, comprising:
a receiver to receive one or more entries from a remote control device, wherein the one or more entries corresponds to at least a partial name of a channel;
a processor to match the at least partial name of the channel against channel data stored in at least one database to form one or more matches;
an output to provide, at a display device, a channel menu comprising the one or more matches;
a receiver to receive a user selection command indicating a selected match from the one or more matches; and
an output to provide, at the display device, the channel corresponding to the selected match.
